(19) United States
(12) Patent Application Publication
(10) Pub. No.: US 2018/0016152 A1
(43) Pub. Date: Jan. 18, 2018

(54) METHOD FOR AEROGEL PRODUCTION AND AEROGEL COMPOSITE MATERIAL

(71) Applicant: FLUMROC AG, Flums (CH)

(72) Inventors: Lukas Huber, Kirchberg (CH); Ivo Kym-Mijuskovic, Uznach (CH)

(21) Appl. No.: 15/548,944

(22) PCT Filed: Feb. 4, 2016
(86) PCT No.: PCT/CH2016/000024

§ 371 Date: Aug. 4, 2017

(30) Foreign Application Priority Data
Feb. 4, 2015 (CH) 147/15

(51) Int. Cl. C01B 33/158; C01B 33/155; C01B 33/145; C03C 25/42; C01B 33/159

(52) U.S. Cl. CPC C01B 33/1585; C03C 25/42; C01B 33/159; C01B 33/145; C01B 33/155; C01P 2006/32

(57) ABSTRACT

The present invention relates to a method for aerogel production and to a composite material produced by said method and comprising an aerogel and mineral fibers. An aerogel material produced on the basis of silicate with a coefficient of thermal conductivity of <18 mW/mK is obtainable by rendering it hydrophobic with HMDSO in the presence of nitric acid.

### CROSS-REFERENCE TO RELATED APPLICATIONS

This application is a national phase entry under 35 U.S.C. §371 of PCT/CH2016/000024 filed on Feb. 4, 2016, which claims priority to Swiss Patent Application No. 147/15 filed on Feb. 4, 2015, the entirety of each of which is incorporated by this reference.

### FIELD OF THE INVENTION

The present invention relates to a method for producing an aerogel 1 and a composite material obtainable by this method as a high-performance insulation material.

### PRIOR ART

Aerogels have a low density and a high porosity with open pores in the range of <50 nm and a large internal surface area. This results in a low coefficient of thermal conductivity. Accordingly, aerogels are also suitable as thermal insulation materials. However, the high porosity also results in a low mechanical stability of the aerogel.

Therefore, in recent years, composite materials made of fiber materials and aerogels have been proposed. Such composite materials may be used as insulation materials, for example. WO 93/06044, for example, discloses a method for producing an aerogel matrix composite material in the following method steps:

Production of an aerogel precursor,

Mixing the aerogel precursor with fibers,

Aging the aerogel precursor containing the fibers to produce a gel,

Immersing the gel in a solvent suitable for supercritical drying, and

Drying the gel under supercritical conditions.

Glass fibers or rock wool fibers, among others, are suitable as fibers that can be embedded in an aerogel. However, the method that is described has the disadvantage that the gel must be dried under supercritical conditions, so that an autoclave is necessary and there must usually be at least one solvent replacement. This is a very complicated and time-consuming procedure. Drying requires a special equipment expense (pressurized reactor for critical point drying; for example, CO₂ at >74 bar/>30° C.). Accordingly, supercritical drying of aerogels is suitable only for small batches and on a laboratory scale.

Because of the complexity of supercritical drying of gels, a method has been developed by which even subcritical drying of the gel at temperatures below 150° C. is possible with a circulating air stream under normal pressure. In subcritical drying of a gel, the free SiOH groups of the resulting gel should first be deactivated for further condensation. This takes place, for example, by adding trimethylchlorosilane to the gel (see F. Schwertfeger, D. Frank, M. Schmidt, “Hydrophobic water glass-based aerogels without solvent exchange or supercritical drying” in Journal of Non-Crystalline Solids, 225 (1998), pp. 24-29). The trimethylchlorosilane here reacts with the OH groups of the silicate surface of the gel, splitting off HCl. Due to the hydrophobization of the silicate surface, water is displaced out of the pores in the gel. Hexamethyldisiloxane and excess trimethylchlorosilane form the organic phase and remain in the pores of the gel. The resulting hydrochloric acid first saturates the aqueous phase and then escapes into the gas phase at higher concentration.

However, the method described here has the disadvantage that it cannot be used in combination with rock wool fibers because the hydrochloric acid that is released partially dissolves the rock wool fibers. Rock wool consists of at least 52 wt % acid soluble fractions (metal oxides such as Al₂O₃, CaO, MgO and Fe₂O₃). For this reason, the aerogels based on glass wool that are currently being used are sufficiently stable at an acidic pH, on the one hand, but have an inadequate thermal stability in the event of a fire, on the other hand.

WO 94/25149 describes a method for producing a highly porous xerogel in which the surface of the gel is hydrophobized with surface-modifying compounds in order to reduce the capillary pressure in the pores of the gel before drying so that the gel will not collapse in the subsequent drying step. This method consists of a sequence of aging, washing, and drying steps. The method that is described is very complex because the gel must be washed with aprotic solvents before and after hydrophobizing with trimethylchlorosilane. The hydrochloric acid which is released in hydrophobizing and would attack rock wool fibers, for example, is also a disadvantage.

DE-OS-196 48 798 describes a method for producing organically modified aerogels by surface modification of the aqueous gel (without prior solvent replacement) and then drying. Hexamethyldisiloxane (HMDSO) may be used as the silylating agent. In addition, a base or acid may also be present as the catalyst in the hydrophobizing reaction.

Advantageous acids include hydrochloric, sulfuric, phosphoric, hydrofluoric, oxalic, acetic or formic acid, but hydrochloric acid is particularly advantageous. Before drying, the silylated gel may optionally be washed with a protic or may be dried under uncritical conditions. Since the use of organic solvents is completely omitted according to the teaching of DE-OS-196 48 798, all the SiOH groups that can be reached by the silylating agent that is used can react with the silylating agent. Therefore, according to DE-OS 196 48 798, a very high degree of coverage of the internal surface of the hydrogel can be achieved.

WO 2013/053951 discloses a method for producing a xerogel with a coefficient of thermal conductivity between 5 and 25 mW/m K, in which in a first process step a sol is poured into a reactor in which a fibrous reinforcing material has previously been arranged. The sol is then gelled, aged and hydrophobized. Next the hydrophobized alcogel is first predried at temperatures up to 80° C. and then completely dried under subcritical conditions and temperatures>100° C. or between 120° C. and 140° C. until the residual alcohol content is <3%. All process steps except for the process step mentioned last can be carried out in the same reactor. It is important that the inside walls 10 are a distance of 70 mm or less from one another. If greater wall distances are selected, then the fiber-reinforced xerogels thereby produced will have a coefficient of thermal conductivity of >25 mW/Km.

The alcogel formed in the second process step has an alcohol content between 15 wt % and 90 wt % relative to the weight of the original sol. The hydrophobization which may be with HMDSO (hexamethyldisiloxane) takes place in the presence of hydrochloric acid at a pH between 1 and 3. Formic acid is proposed as an alternative for the use of hydrochloric acid.

U.S. Pat. No. 5,746,992 relates to the production of a silicon aerogel. In this production process the alcohol is removed from the alcogel under subcritical conditions. According to one exemplary embodiment, the hydrolysis of tetraethoxysilane takes place in two steps. In a first step, the tetraethoxysilane, methanol, some water and nitric acid are mixed together in a class container, then the glass container is sealed and kept at 60° C. for 24 hours. During this time the tetraethoxysilane partially hydrolyzes under acidic conditions. Then the mixture is adjusted to a basic pH by adding an aqueous/alcoholic ammonia solution and kept again at 60° C. for 24 hours to achieve a secondary hydrolysis under basic conditions. Under these conditions, a clear silicic acid gel is obtained, having an internal porosity of 74% after drying in an oven. According to U.S. Pat. No. 5,746,992 no hydrophobization of the gel is provided.

WO 2015/014813 discloses a method for producing an aerogel material similar to that of WO 2013/053951. As already described in WO 2013/053951, an alcogel is first produced in an alcoholic medium and then allowed to react with an activatable, acid-catalyzed hydrophobizing agent, namely HMDSO in the present case. What is novel about this in comparison with WO 2012/053951 is that the hydrophobizing agent HMDSO Is already added to the silicon oxide sol in the first process step. The amount of the hydrophobizing agent in the sol here amounts to 3 to 80% by volume. This is activated only by forming the gel, which may optionally also be aged, by the release or addition of at least one hydrophobization catalyst that works together with the hydrophobizing agent.

WO 2015/014813 describes one exemplary embodiment for producing granules, characterized in that the gel that has been formed and aged is pulverized mechanically, then transferred to a closed pressurized container and hydrophobized by means of HCl in the presence of HMDSO, then predried on a conveyor belt at 50° C. and finally dried completely at 150° C.

In another example, an aerogel insulation sheet is produced by mixing an alcoholic solution with a polyethoxydisiloxane sol with a 22% SiO₂ content and HMDSO with a slow-release agent doped with 10% HCl. After adding an ammonia solution, the thoroughly mixed sol is poured into a mold which had previously been lined with a polyester nonwoven fiber matte. After aging for 5 hours, the gel sheet is lifted up from the mold and stored in a closed vessel for 24 hours at 65° C. and hydrophobized. At this temperature, HCl escapes from the microencapsulation and activates the HMDSO that is present. The vessel is then opened and the gel sheet is first dried at 50° C. and then at 130° C.

### Advantages of the Invention

The advantage of the present invention is a method for aerogel production that can be carried out as inexpensively as possible. In addition, the method permits production of an aerogel material on an industrial scale in the most environmentally friendly way possible. The aerogel material (not including a fiber matrix) may have a porosity of >80%, >90%, or >92%, and a density of <0.2 g/mL, 0.15 g/mL, or <0.12 g/m L. Another advantage is supercritical drying of the aerogel material to be unnecessary in production. Another advantage is to provide an aerogel composite material, which may also contain acid-sensitive fibers, for example, rock wool fibers. One advantage is to make available a fiber-aerogel composite material with a coefficient of thermal conductivity λ of <20 mW/mK, or <18 mW/mK, which can be produced on an industrial scale.

### DETAILED DESCRIPTION OF THE INVENTION

The invention relates to a method for producing an aerogel in which a silicatic sol is first prepared by hydrolyzing an organosilane compound, e.g., tetraethoxysilane (TEOS) under acidic or basic conditions, then producing a gel by adding a base to the sol and next aging the resulting gel. After aging, the gel is hydrophobized with a silylation agent in the presence of an acid as the catalyst, and then the gel is dried, as by subcritical drying. For production of the aerogel or xerogel, essentially the same processes and parameters may be used as those described in WO 2013/053951 or WO 2015/014813.

Within the scope of the present invention, aerogels should be understood to be highly porous solids, in particular those based on silicate, regardless of the drying method. The term “aerogel” is understood to be a highly porous material with air as the dispersant in this sense.

According to the invention, the advantages are achieved by a method of producing an aerogel by using hexamethyldisiloxane as the hydrophobizing agent and nitric acid (HNO₃) as the acid. The process according to the invention has the great and surprising advantage that the hydrophobization in the presence of nitric acid produces highly porous stable aerogels with excellent low thermal conductivities. In particular aerogels with a porosity of <90%, or >92% and with a coefficient of thermal conductivity of <18 mW/mK can be produced on an industrial scale with the process according to the invention.

The silicatic sol is advantageously prepared by hydrolysis of alkoxysilanes or hydroxyalkoxysilanes, such as from tetraethoxysilane (TEOS) or trimethylchlorosilane. Use of TEOS has the advantage that it is soluble in alcohol, e.g., EtOH. Accordingly, the sol can be prepared in alcohol, an alcoholic or alcohol-containing solvent mixture, which is advantageous for the process because then there is less water in the pores of the gel which is formed later. An alcoholic solvent mixture should be understood to be a mixture in which alcohol is the main ingredient, such as in a volume amount of >90 vol % or >95 vol %. On the other hand, an alcohol-containing solvent mixture should be understood to be one in which the percentage volume amount of the alcohol(s) is <50 vol % or <40 vol %.

The sol is advantageously prepared in an acidic medium by hydrolysis of tetraethoxysilane (TEOS) which is placed in a solvent such as EtOH. Hydrochloric acid or formic acid may be used for the hydrolysis. According to a particularly advantageous process variant, a prehydrolyzed sol is used. This makes it possible to greatly shorten the process of production of the gel. Prehydrolyzed sols are stable and can be stored and are also commercially available. Prehydrolyzed sols which are present in an amount between 5% and 30% (w/w) SiO₂ or between 10% and 25% (w/w) SiO₂ in alcohol, such as EtOH, are used.

The pH in hydrophobization is advantageously set at a value between 1 and 7, or between 2 and 5. In the acidic range at approx. pH 2, HMDSO reacts rapidly with the SiOH groups that are still free.

The pH in hydrophobization is advantageously set at a value between 0.2 and 5, between 0.5 and 3 or preferably between 0.8 and 2. The pH is measured in the aqueous phase. Such a pH is advantageously compatible with rock wool fibers when using nitric acid as the hydrophobization catalyst.

The gelation expediently takes place in a temperature interval between 30° C. and 80° C., between 50° C. and 75° C. and or between 60° C. and 70° C. For gelation of the sol, a base, e.g., ammonia in the form of an aqueous ammonia solution, is added to the mixture.

The hydrolysis, gelation and hydrophobization are advantageously carried out in an essentially alcoholic solvent, such as EtOH, where the water content is expediently <20 vol %, <10 vol % or <5 vol %. It has been found that a low water content has a positive effect on the quality of the aerogel produced.

For the production of a fiber composite material, fibers may be added before and/or during the production of the gel. The fibers are may be added before the actual gelatin (condensation), i.e., the fibers and the sol may be mixed together between steps a) and b). Rock wool fibers are especially used advantageously. These have the great advantage that they are practically nonflammable.

By optimizing the individual process steps it is surprisingly possible to carry out the hydrophobization without prior solvent replacement. This has the major advantage that on the one hand the process proceeds more rapidly, while on the other hand smaller amounts of solvent are consumed.

It is fundamentally conceivable to add the silylation agent already in process step a). This is possible, for example, when a silylation agent that is stable in an alkaline medium is used and the sol preparation and gelation take place in the alkaline medium. HMDSO, for example, is a suitable silylation agent that is stable in an alkaline medium.

The subject matter of the present invention is also an aerogel, in particular a xerogel obtainable by

a) Preparing a sol,
b) Producing and optionally aging the gel,
c) Hydrophobizing the gel with a silylating agent in the presence of an acid as catalyst and

### d) Drying the gel.

e) Hexamethyldisiloxane is used as the hydrophobizing agent and nitric acid (HNO₃) is used as the acid.

Additional advantageous properties of the gel have already been explained in the discussion of the production process.

Another subject matter of the present invention is an aerogel fiber composite material obtainable by mixing the sol prepared according to the method described here with mineral fibers, in particular rock wool fibers. The aerogel composite material has a porosity of >90% and a coefficient of thermal conductivity of <18 mW/m K. The mineral fibers are surprisingly not dissolved to any significant extent during this production process. In particular because of the known acid sensitivity of rock wool fibers it could not have been expected that the hydrophobization treatment could be carried out successfully under acidic conditions.

Although fundamentally glass wool fibers could also be used to produce the composite material, rock wool fibers are particularly advantageous. Rock wool fibers have the advantage over glass wool fibers that their fire resistance is much better.

Additionally, the subject matter of the present invention is a composite material in the form of an insulation sheet consisting of the aerogel and mineral fibers according to the invention.

The invention is described in greater detail below on the basis of the following exemplary embodiments.

Production of an Aerogel

Starting with 122 L ethanol (abs. and denatured with 2% methyl ethyl ketone (MEK)), 47 L TEOS (98%) are then added. The mixture is then heated to approx. 50° C. Next 14 L oxalic acid solution (2.44 g=0.0193 mol) is added while stirring. For the hydrolysis, the solution is stirred for about 24 hours at 50° C., then the mixture is allowed to cool to 45° C. and 36.5 mL NH₄OH solution (28-30%) in 8 L water (=0.07M) is added. Next the mixture is left to stand for approx. 24 hours (without stirring). Gelation occurs during this period of time. Next the gel is optionally washed dynamically once or twice with heptane and then hydrophobized (see below). The subsequent hydrophobization also takes place dynamically by recirculating the silylating agent (approx. 15 hours at approx. 60° C.). As soon as hydrophobization is concluded, the solvent/hydrophobizing agent mixture is drained out, processed and later reused in the next production process.

Hydrophobization of a Lyogel with Trimethylsilyl Chloride

Reaction of the lyogel under acidic conditions, which leads to the decomposition of rock wool: 1.6 g lyogel (from 7% SiO₂ tetraethyl orthosilicate with rock wool) was combined with 10 mL trimethylsilyl chloride. The rock wool disintegrates overnight to form a yellowish fibrous and mechanically unstable substance. Composite materials prepared in this way are hydrophobic, highly porous and float on water.

Hydrophobization Experiments with HMDSO Using Various Organic and Inorganic Acids as Catalysts

Various organic and inorganic acids, e.g., sulfuric acid (H₂SO₄), hydrochloric acid (HCl), phosphoric acid (H₃PO₄), oxalic acid, formic acid and acetic acid were used as the hydrophobization catalysts. In all these experiments, the resulting aerogel rock wool fiber composite material had a “vitreous” (transparent) appearance and a few or many fissures. In some samples, a definite shrinkage was also observed after drying. The measured coefficient of thermal conductivity values varied in the range above 20 mW/mK and were therefore unsatisfactory in view of the requirements of a high-performance insulation material.

According to the experience of the inventors, based on a number of experiments, samples (rock wool fiber matrix and aerogel), which appear to be vitreous and/or undergo shrinkage in drying have a much higher coefficient of thermal conductivity than those which appear to be “translucent” or “milky” and have practically no fissures and do not shrink when dried. Samples with a conductivity value between 16 and 18 mW/mK have a blue cast and practically no fissures.

The coefficient of thermal conductivity was determined according to the EN 12667 standard (standard hot plate method) at 20° C. and normal pressure.

Production of the Aerogel Fiber Composite Material

55 L of a prehydrolyzed sol (75% prehydrolyzed; 20% (w/w) SiO₂ content) in EtOH (abs.) is mixed with slightly more than twice that amount of ethanol (130 L) and homogenized while stirring. At the same time, the mixture is heated to approx. 45° C. As soon as the temperature has been established and the mixture is homogenized, an aqueous NH₄OH solution (approx. 6 L; 0.55M) is then added to the sol, homogenized briefly and next transferred to a container that already holds a fiber matrix equipped with a temperature sensor. Next the contents of the container are heated to approx. 65° C. and the mixture is left to stand for aging. The aging of the gel takes place between 24 and 120 hours, between 48 and 96 hours or for approx. 72 hours.

After gelation, the gel is hydrophobized dynamically in the same container by adding an excess of HMDSO (in the present case approx. 270 L of a 20 to 98% (w/w) HMDSO solution) and approx. 5 L of an essentially alcoholic HNO₃ solution (approx. 4 to 7% w/w) for 24 hours at 75° C., i.e., by circulating the liquid phase.

After cooling, the partially spent hydrophobizing solution is transferred to a mixer/settler and the prepared aerogel fiber composite material is dried in a circulating air oven for 2 to 5 hours at approx. 150° C.

Water is added to the partially spent hydrophobizing solution (approx. 10% of the volume of the hydrophobizing solution) in the mixer/settler and the mixture is stirred intensely for 10 to 30 minutes. Then the mixture is left to stand overnight, whereupon an aqueous phase separates at the bottom. The aqueous phase is separated and discarded. The alcoholic hydrophobizing solution can then be reused in the next batch, optionally after being concentrated with HMDSO.

The present invention relates to a method for producing aerogel and a composite material produced by means of this method from an aerogel and mineral fibers. An aerogel material produced on the basis of silicate with a coefficient of thermal conductivity coefficient of <18 mW/mK can be obtained by hydrophobizing the aerogel material with HMDSO in the presence of nitric acid.

1-19. (canceled)

20. A method of producing an aerogel, comprising:
preparing a silicatic sol;
producing a gel from the silicatic sol;
hydrophobizing the gel with a silylation agent comprising hexamethyldisiloxane in the presence of an acid comprising nitric acid (HNO₃) as a catalyst; and
drying the gel by subcritical drying.

21. The method of claim 20, further comprising aging the gel prior to hydrophobizing the gel.

22. The method of claim 20, further comprising producing the silicatic sol by hydrolysis of alkoxysilanes or hydroxyalkoxysilanes.

23. The method of claim 22, further comprising producing the silicatic sol by hydrolysis of tetraethoxysilane (TEOS) or trimethylchlorosilane.

23. The method of claim 20, further comprising preparing the sol in alcohol.

24. The method of claim 23, further comprising preparing the sol in ethanol or a solvent mixture containing alcohol.

25. The method of claim 20, further comprising using prehydrolyzed sol as the a silicatic sol.

26. The method of claim 20, further comprising adjusting a pH during hydrophobization of the gel to a value between 0.2 and 6.

27. The method of claim 26, further comprising adjusting the pH during hydrophobization of the gel to a value between 0.5 and 5.

28. The method of claim 27, further comprising adjusting the pH during hydrophobization of the gel to a value between 0.8 and 3.

29. The method of claim 20, further comprising preparing the silicatic sol by hydrolysis of tetraethoxysilane (TEOS) with an amount by weight between 5 and 30 wt % SiO₂.

30. The method of claim 29, further comprising preparing the silicatic sol by hydrolysis of tetraethoxysilane (TEOS) with an amount by weight between 10 and 25 wt % SiO₂.

31. The method of claim 20, wherein gelation takes place in a temperature of between 30° C. and 80° C.

32. The method of claim 31, wherein gelation takes place in a temperature of between 60° C. and 70° C.

33. The method of claim 20, further comprising performing the preparation of the silicatic sol, production of the gel from the silicatic sol and hydrophobization of the gel in a single reactor.

34. The method of claim 20, further comprising mixing the silicatic sol with mineral fibers before producing the gel from the silicatic sol.

35. The method of claim 34, further comprising using mineral wool fibers as the mineral fibers.

36. The method of claim 20, further comprising performing the hydrophobization in situ without prior solvent replacement.

32. The method of 20, further comprising adding the silylating agent when preparing the silicatic sol.

33. An aerogel produced by method steps, comprising:
preparing a sol,
producing a gel from the sol and aging the gel; and
hydrophobizing the gel with a silylating agent comprising hexamethyldisiloxane in the presence of an acid comprising nitric acid (HNO₃) as catalyst.

34. The aerogel of claim 33, further comprising mineral wool fibers mixed with the sol to form a composite sol-mineral fiber mixture.

35. The aerogel of claim 34, wherein the composite sol-mineral fiber mixture forms an insulation sheet.

36. The aerogel of claim 34, wherein the mineral wool fibers comprise rock wool fibers.

37. The aerogel of claim 34, wherein the composite sol-mineral fiber mixture has a coefficient of thermal conductivity of <20 mW/mK.

38. The aerogel of claim 27, wherein the composite sol-mineral fiber mixture has a coefficient of thermal conductivity of <18 mW/mK.
